(19) United States
(12) Patent Application Publication
(10) Pub. No.: US 2016/0094491 A1
(43) Pub. Date: Mar. 31, 2016

(54) PATTERN-CONTROLLED AUTOMATED MESSAGING SYSTEM

(71) Applicant: Genesys Telecommunications Laboratories, Inc., Daly City, CA (US)

(72) Inventors: Sergey Fedorov, Moraga, CA (US); Herbert W.A. Ristock, Walnut Creek, CA (US)

(21) Appl. No.: 14/503,258

(22) Filed: Sep. 30, 2014

(51) Int. Cl. H04L 12/58; H04L 29/08

(52) U.S. Cl. CPC H04L 51/02; H04L 67/1002

(57) ABSTRACT

A system has a router connected to one or more channels, a server connected to the network having a processor coupled to at least one data repository and software executing on the processor, and one or more templates, each template dedicated to a particular objective and comprising one or more representations of data related to the objective of the template, and required to accomplish the objective. Upon receipt of a transaction from a sender, the router routes the transaction to the server, which determines an objective for the transaction, selects the template dedicated to the determined objective, compares input from the transaction against the one or more representations of data, matches input data to the data representations, determines when and if all data representations are satisfied, and stores in the data repository the matched input data associated with the data representations and with the sender.

### BACKGROUND

1. Field

The present invention is in the field of telecommunications and pertains more particularly to methods and apparatus for managing communicated input provided in a communications session captured in media.

2. Discussion of the State of the Art

In the field of telecommunications, Interactive voice response (IVR) technology is known for interaction between customers and a business entity, for example. IVR interaction is often complex with many prompts and sub-prompts, which may have to be re-navigated by going back in the menu or calling again if solicited information was not completely captured from the customer. Message recording is also available, both in IVR systems and voice mail systems for capturing voice messages from calling parties. In a voice mail system or with other message recording applications or devices, a greeting is typically provided at the beginning of the routine followed by a voice message left on the recorder and confirmation by the system of success of the recording process.

Voice mail is typically a manual process wherein the receiving party evaluates the recorded message and gets back to the caller if information is not complete. Because of its simplicity, voice mail is rather limited as a tool for retrieving much rich information from a caller. An IVR, on the other hand, may be too complex and may take significant time to retrieve the desired data from the caller.

Therefore, what is clearly needed is a system that captures rich information from callers while avoiding or minimizing too many prompts and sub-prompts that are typical in IVR systems, to capture the many categories of input.

### BRIEF SUMMARY

Embodiments of the present invention are directed to a customer contact center system that includes a data storage device storing a plurality of templates, where each template has a plurality of data input fields. The system further includes a communication router connected to one or more communication channels in a network for routing a communication transaction from a sender, and a server connected to the network having a processor coupled to at least one data repository and software executing from a non-transitory medium on the processor. According to one embodiment, the server is configured to receive the routed transaction from the router, select one of the plurality of templates, receive a first input from the transaction, select a first data input field from the plurality of data input fields based on the first input, and store the first input in association with the first data input field and the sender.

According to one embodiment, the network is at least one of a publically switched telephone network (PSTN), a digital cellular network, or a data network.

According to one embodiment, the server is further configured to identify a second data input field from the plurality of data input fields; determine, at a preset juncture, whether a second input associated with the second data input field, has been received from the transaction; and in response to determining that the second input has not been received, prompt the sender for the second input.

According to one embodiment, the preset juncture is a pause in the transaction with the sender remaining connected in the transaction, and the server is configured to transmit the prompt during the transaction.

According to one embodiment, the preset juncture is disconnection of the transaction, and the server is configured to transmit the prompt in a separate transaction.

According to one embodiment, the network supports voice transaction, the transaction is a voice call, and the prompt is a recorded voice message identifying the second input.

According to one embodiment, the network supports data transactions, the transaction is a text message, and the prompt is a text message identifying the second input.

According to one embodiment, the server supports voice and data transactions, the transaction is at least one of voice or text, and the prompt is a notification utilizing at least one of voice or text.

According to one embodiment, the server is configured to transmit a request to a source on the network other than the sender of the transaction, for the second input.

According to one embodiment, the transaction is a telephony call, the first input includes utterances from the sender during the telephony call, and the server is configured to: recognize the utterances from the sender; identify a first tag identifying the first data input field based on the recognized utterances; and store a text-based representation of at least a portion of the recognized utterances in association with the first data input field and the sender.

### BRIEF DESCRIPTION OF THE SEVERAL VIEWS OF THE DRAWINGS

FIG. 1 is an architectural overview of a network supporting voice and text interaction according to an implementation of the present invention.

FIG. 2 is a block diagram depicting a template having tagged input fields according to an implementation of the present invention.

FIG. 3 is a block diagram depicting voice mail function according to an implementation of the present invention.

FIG. 4 is a process flow chart depicting steps for configuring and operating a messaging system according to an implementation of the present invention.

FIG. 5 is a block diagram depicting components for appending input solicited from a user according to an implementation of the present invention.

FIG. 6A is a block diagram of a computing device according to an embodiment of the present invention.

FIG. 6B is a block diagram of a computing device according to an embodiment of the present invention.

FIG. 6C is a block diagram of a computing device according to an embodiment of the present invention.

FIG. 6D is a block diagram of a computing device according to an embodiment of the present invention.

FIG. 6E is a block diagram of a network environment including several computing devices according to an embodiment of the present invention.

### DETAILED DESCRIPTION

Various embodiments of the present invention are directed to a pattern-controlled automated messaging system.

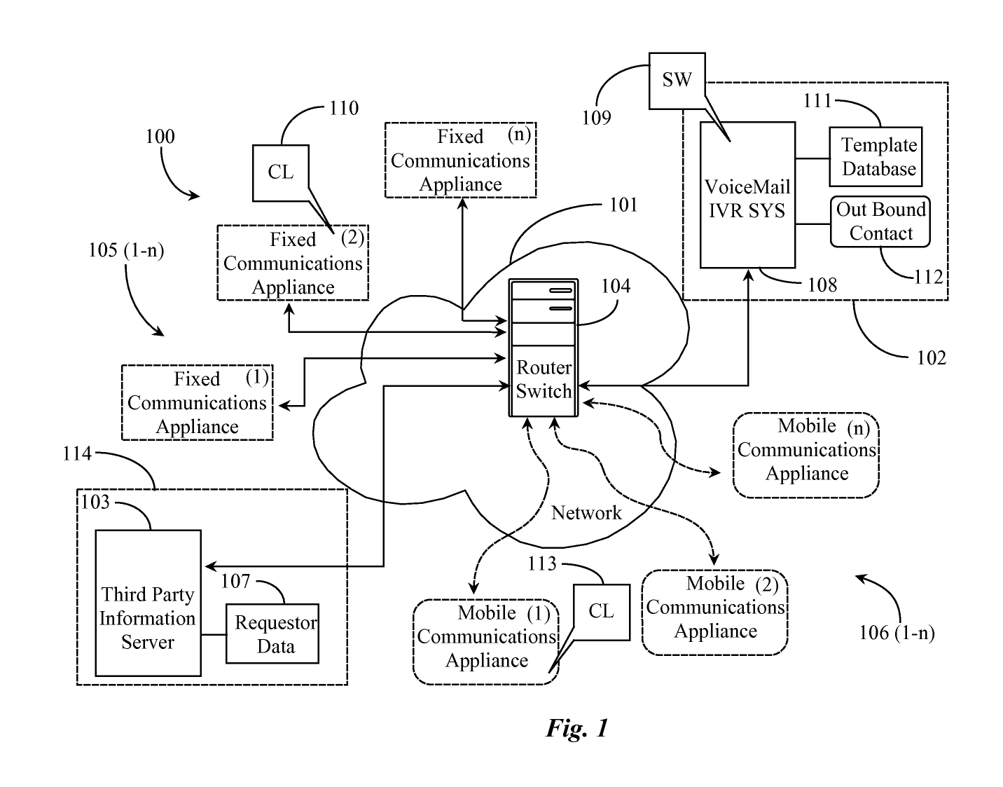

FIG. 1 is an architectural overview of a network 100 supporting voice and text interaction according to an implementation of the present invention. Network 100 is a system of communications endpoints connected together for network communication. Network cloud 101 may represent a communications network domain such as the Internet network and any connected sub networks such as wireless data networks, public telephone networks, and wired voice/data networks operating over Internet protocols and so on. Network cloud 101 may represent all of the lines, equipment, and access points that make up the larger communications network as a whole. Therefore, there are no geographic limits to the practice of the present invention. One with skill in the art of telecommunications will appreciate the seamless nature of communication over a conglomerate of carrier and transport networks.

A communications router 104 is illustrated within the domain 101 of network 100. Communications router 104 may be a telephone switch in a publically switched telephone network (PSTN). Router 104 may also be a multimedia router connected to the Internet network through a local sub-network and capable of routing data and voice. Communications router 104 may route all communication in this example. Router or switch 104 may have connection to a voicemail or IVR system domain 102. Domain 102 may represent a call center or other business entity providing or hosting communications services. In the case of IVR, domain 102 may be a call center that utilizes IVR services to interact with customers. In the case of a voicemail system, domain 102 may be a call center that contracts with a voicemail service or a third party business offering general voicemail services to individuals or small businesses.

Domain 102 includes a server 108 that provides one or both of voicemail and IVR services. Server 108 may include a processor, at least one connected data repository and memory storing all of the data and instruction required to function as either an IVR system or as a voicemail system or as both. Server 108 in this example hosts software (SW) 109, which may include IVR and or voicemail SW required to operate basic services. In one implementation both IVR and voicemail services may be provided by the same service entity.

SW 109 in this example includes voice-recognition software adapted for pattern-controlled free speech voice recognition according to an implementation of the present invention. SW 109 may also include a user interface, such as a browser-based or browser-nested interface, that enables a user to create a process template that has a structure and context that is based upon an expected subject of and an outcome of an interaction. For example, a template may have structure and a specific number of data input fields for capturing caller input that is relative to the expected subject. Elements of the callers input may be solicited in a voicemail greeting or IVR menu selection.

In this implementation users are depicted as fixed communications appliances 105 (1-n), that may be desktop computers, fixed telephone sets, or a combination of different sorts of communication appliances. In this implementation mobile users are depicted as mobile communications appliances 106 (1-n), which may be smart telephones, cellular telephones, laptop computers, or other mobile appliances enabled at least for voice communication over a network. Mobile communications appliances 106 (1-n) may connect to voicemail/IVR server 108 via router/switch 104. Fixed communications devices 105 (1-n) may also gain network access to server 108 via router 104.

A person with skill in the art of network infrastructure will appreciate that there are a variety of wired and wireless networks through which fixed and mobile communications appliances may access server 108 for services. In one implementation private or individual users operating communications appliances 105 (1-n) and 106 (1-n) may navigate to a Website hosted by a service provider (not illustrated) to register for voicemail services. Business entities associated with fixed or mobile communications appliances may navigate to a Website hosted by a service provider and register for IVR services for their customers.

SW 109 may include search software adapted to enable captured input to be matched to one or more specified data fields within a template. The caller's input may be delivered naturally and in random order with respect to the possibly multiple and different elements of the caller's solicited data. Voice recognition SW may recognize the caller's input (voice). Input that is captured is matched against keywords phrases or other data provided to classify the input fields in the template. According to one embodiment, the input is translated to text and stored in association with the matching input fields of the template.

Server 108 in one implementation has connection to an outbound contact server 112. Server 112 may include a processor, at least one data repository, and a memory containing thereon all the data and instruction required to enable function as an outbound contact server. In one implementation outbound server 112 may comprise an automated voice dialing system and an automated messaging system. Outbound contact server 112 may make contact with fixed and mobile communications appliances through router/switch 104 and appropriate media gateway.

In one implementation of the invention the system may determine after processing a call against a template whether the caller provided all of the information needed for use in completing the associated SW template fields. This may occur while the caller is still online in the active call, perhaps after a brief pause, or may be done after the caller disconnects. If the former, the system may select pre-recorded prompts to the caller based on the nature of the information deemed to be missing. In the case of the caller having disconnected, if the caller failed to provide some required information the system may initiate an outbound contact such as a voice call, a text message, or an email to try to retrieve the missing information. The nature of the prompts or after-call contacts are determined from the unsatisfied tags or fields of the template. In one implementation SW 109 on server 108 may be adapted to obtain information about a caller from a network-connected source such as a third-party service provider. In this implementation a service provider domain 114 is depicted including a third party information server 103. Server 103 includes a processor and at least one data repository coupled thereto and memory storing all of the data and instruction required to function as an information server connected to the network.

Server 103 has connection to a data repository 107 containing caller data. Caller data may include social interaction profile data, user preference data relative to communication methods, user location data, user billing history, etc. A caller in broad sense here is a person that leaves information on a voicemail recording or that interacts with an IVR enhanced to practice an embodiment of the present invention. SW 109 may include third-party resources in search domain mapping so that SW templates may be automatically appended with updated information about a caller or with information the caller provided in error or failed to provide on the first processing (missing data). Domain 114 may be within the domain of service provider 102 such as collocated at a same premise with server 108.

In one implementation server 108 is a voicemail server and manages voicemail interaction for a registered user base. A registered user base may include a group of business users, such as all salesmen for a particular company, for example. A registered user base may include any private individuals signed up to participate. For example a user selling produce out of a home or from a stand may configure voicemail according to the business of growing and selling garden produce (subject). The user interface may be accessed and used to configure a template with fields representing information that the seller wishes to have from the calling party. A requestor may leave a recording from any of appliances 105 (1-n) or 106 (1-n).

In one implementation of the invention server 108 may receive and serve text messages in conjunction with or in place of voice recording and prompting. Entities expecting to receive a text message may provide pre-specified instruction at messaging access links relative to what information is desired in a message left by the caller or text messenger. SW 109 is enabled to parse incoming text messages for the expected information. A search function matches the received information to the template. If any information is missing, automated action may be taken such as searching third party resources for the missing parts or replying to the requestor and prompting for the missing information. Other supported processes may include chat, file transfer, streaming media, and so on. When all of the expected information is received according to the template, the process may be deemed complete or enough information has been received and verified to progress to a next phase in a process, for example.

In one implementation of the invention a requester may leave a voice message with data that is missing and the system, whether IVR or Voicemail, may reply back with a text message to solicit the missing data. In a variation of this implementation, expected data is left on the voice recording and specified other data such as authorization code, personal identification number, password, or other personal or authentication data is retrieved from the requestor via a separate channel like SMS or email.

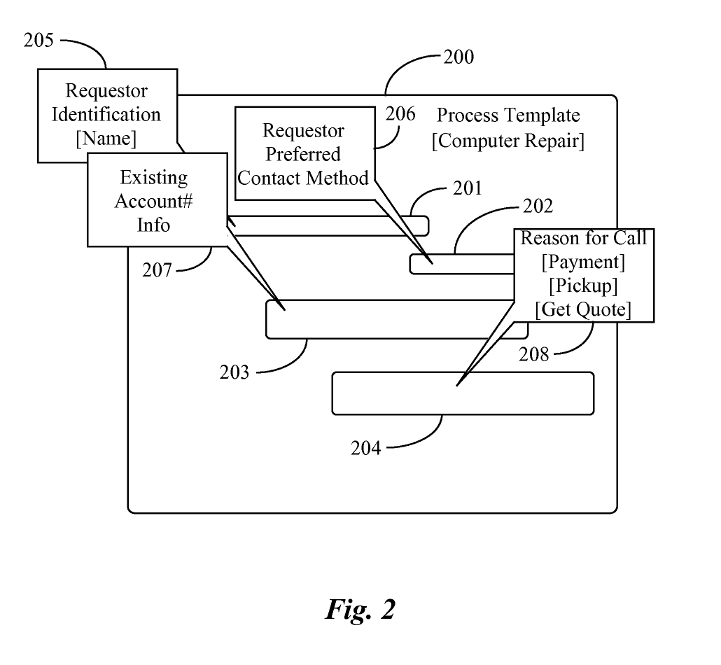

FIG. 2 is a block diagram depicting a process template 200 having tagged information fields according to an implementation of the present invention. Template 200 has a plurality of information fields for information to be captured from a caller voice recording or message. Template 200 is relative in terms of expected field content to a specific subject that the requested party expects messages to be about. In this implementation template 200 may be based on a computer repair order from a customer of a computer repair shop, for example.

Template 200 includes a plurality of fields 201 through 204. There may be more or fewer fields in template 200 without departing from the spirit and scope of the present invention. Fields may have one or more than one associated sub field which in turn may have further sub fields associated in a hierarchy. In this simple implementation there are four separate fields. A user operating a user interface such as one described above with respect to SW 109 may create classification tags for each data field in template 200.

A classification tag may comprise a list of keywords, phrases, characters, bar codes, and other indicia that may represent the sort of data that should go into the field. Field 201 has a classification tag 205 associated with field 201 and classifies requestor identification. Key words and phrases may include name, full name, identification number, badge number, or other like expressions. Classification tag 206 is associated with field 202 in this implementation and may classify requestor preferred contact methods and or times. Key words and phrases may include email, SMS, chat, phone, phone after 6 PM, etc. Classification tag 207 is associated with field 203 in this implementation and may classify existing account information. Key words and phrases may include account number, reference number, balance, open order numbers, etc. Classification tag 206 is associated with field 204 in this implementation and may classify a reason for the request or call. Key words and phrases may include making payment, pickup order, get quote, etc.

Template 200 may comprise a loosely associated set of input fields or multiple fields organized in a hierarchical order. Phrases and keywords detected by voice recognition SW or text recognition SW are matched against the classification tags 205 through 208. Field data may adhere to one or more separate formats for expressing data like certain character strings or date and time formats. SW 109 of FIG. 1 may include data conversion utilities including formatters and operating system APIs so data may be transferred seamlessly into the data fields. Any automated process that has integration with the system and apparatus of the present invention may interpret data fields 201 through 204. In one implementation of the present invention data fields 201 through 204 are human readable and data therein may be checked and amended or modified.

In one implementation template 201 may be distributed over the network to another system or automated process server for process implementation. As one example a user may leave a voicemail message requesting a specific product for purchase and shipping to the user's address. The voicemail greeting lists the data items that may be required for a purchase to be accomplished. These may include buyer name, shipping address, contact (email, telephone), account number, and method of payment. The buyer may provide the data randomly using natural language in a voicemail or IVR scenario. The voicemail may be automatically processed for all of the data needed to accomplish the transaction. Any of various well known voice recognition algorithms may be employed for automatically processing and recognizing the recorded voice message, such as, for example, Hidden Markov models. According to one embodiment, the recognized voice utterances are converted into text.

In one circumstance all of the provided data may be matched successfully to the appropriate data fields 201 through 204 in the template, and further buyer involvement in the process is not required, assuming the buyer has previously provided payment method and an account (card number, etc.) is on file for the caller (buyer). In another implementation the buyer may have not provided all of the information required to complete the transaction without further involvement. In such a case there may be a pre-specified period of delay imposed after the buyer leaves a message while the apparatus processes the information left in the message to determine if all of the required data is available for filling in the template.

A message confirmation prompt may be presented to the buyer before the buyer hangs up. The message confirmation prompt may confirm to the buyer that all of the data was received and the buyer may hang up. A “missing data” prompt may be presented to the buyer in a case where there is data missing or otherwise unavailable. The “missing data” prompt may solicit the buyer for the missing data. The buyer may then leave the missing data on the voicemail system in a second recording. In one implementation the process may repeat until a confirmation prompt is presented to the buyer.

In another implementation the buyer may leave a voicemail message and may provide all of the required information on the recording except for authentication data or some personal data that the buyer does not want to leave on a recorded voice message. The apparatus may send a SMS text to the buyer soliciting the buyer for the security or personal data for authentication. The buyer may hear a confirmation message when the SMS reply containing the security data has been received and checked for authentication. The buyer may then hang up. The buyer now has two channels tied to the order and may receive further information through either preferred channel.

In an alternative implementation of the invention the processes described in implementations of this invention might be applied to a multi-step transaction, where certain information is required at each stage of the transaction. Additional information required at each advancing stage might depend on how the case evolves, and under some circumstances older information might need to be replaced or enhanced at a later stage. Under some circumstances in such a use case, a client might be encouraged to enter information early for later stages, which information might be corrected or enhanced later. The early entry could save time in the event that the earlier-entered information was correct, and need not be corrected later. In this implementation there may be a passage of time between stages, and session ID may be kept to pick up sessions for new stages as needed.

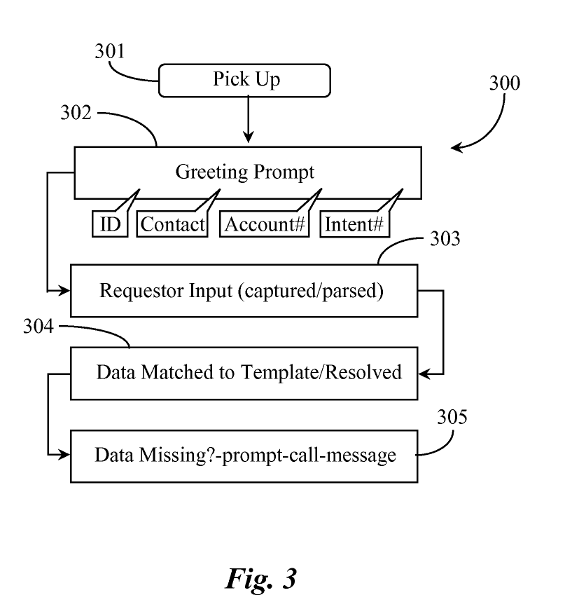

FIG. 3 is a block diagram 300 depicting voicemail function according to an implementation of the invention. In this implementation the voicemail system picks up a call in act 301. The act of intercepting the call is automated for voicemail and IVR implementations. In act 302 the voicemail system may play a greeting prompt to the requestor. The greeting prompt may solicit the data that is minimally required to accomplish a process or transaction that is the subject matter of the call. In this example data solicited by the greeting prompt includes identification (ID of caller), contact information, account number, and intent of the call. The receiving party expects the caller to leave all of the expected data on the voice recording for voicemail or IVR implementations using dual tone multiple frequency (DTMF). Voice over Internet Protocol (VoIP) may also be used as a voice protocol. In one implementation connections between communications appliances and server are set up using session initiation protocol (SIP).

Assuming the caller left all of the expected data in the message, the system analyzes the message data and parses or otherwise recognizes the information at act 303. The system matches the captured information against the classification tags associated with the template fields as described above with respect to FIG. 2. A goal of this act is to resolve the template (all fields containing correct data). The process is over if the template can be resolved with the caller's information left on the recording. No further involvement of the caller is required.

The system may, however, determine that some data is missing in act 304. In one implementation a measured delay period is enforced on a voice system. The system may inform a caller in the original greeting (voicemail) or menu prompt (IVR), to stay on the line until a confirmation prompt or “missing data” prompt is served after the delay period. In the event data is missing, the apparatus may attempt to find the data before asking the caller for it. For example, caller data may be found in a first party or third party location on the network and added to the template during the delay period. In such a case, the confirmation prompt may be played to the caller (data missing but found elsewhere). If the apparatus is not successful in finding the missing data a “missing data” prompt may be served in act 305. The caller may be solicited for missing data over another channel that is different from the channel used to connect to the system, like email or SMS.

It is important to note herein that the invention is not limited to voicemail or voice IVR systems. The system may support text messages, email messages, or text IVR interaction. In such implementations message replies may be initiated by the system and routed to users to solicit missing data. In some implementations the system supports more than one media channel simultaneously such as voice and text messaging, for example.

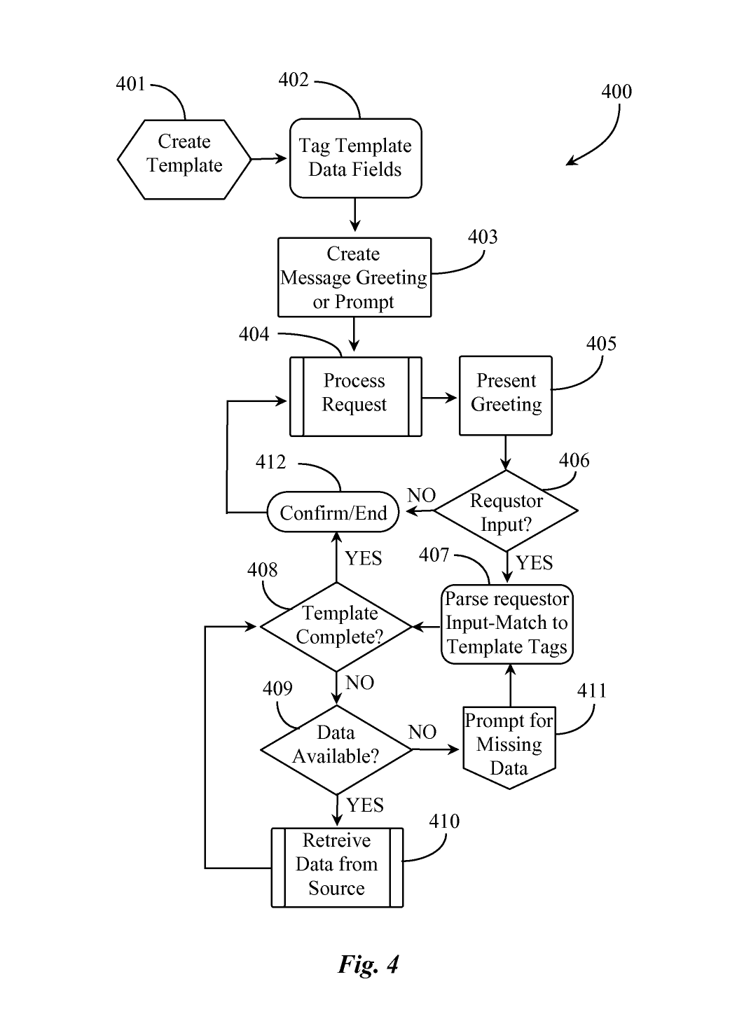

FIG. 4 is a process flow chart 400 depicting steps for configuring and operating a messaging system according to an implementation of the present invention. In act 401 a user operating a communications appliance connected to the network may create a process template. The template may be created through a user interface provided by a browser-based application. In a voicemail implementation and in IVR implementations data fields are added to the template and individually classified as to what type of data belongs in each field in act 402. The classifications are tagged to the fields and are used as matching criteria for captured voice data left by a user in a voicemail or IVR recording.

It should be apparent to the skilled person that steps 401 and 402 in FIG. 4 are presented at a high level, and there may be considerable further detail both in template creation and in the creation and tagging of data fields. For example, some data may be absolutely mandatory, some may be highly desired, some may be optional. There may be, that is, different levels of priority and importance in data to be solicited from a user interfacing with the system. These levels of importance may be in some implementations built into the tagging of the data fields, and may require certain difference in the system's interaction with the user. The system may, for data tagged as absolutely required, circle back over and over for that data if the user fails to completely provide the data, but the system may inquire only once for data that is tagged as optional. In some cases data might be tagged as highly confidential, and retrieval and processing of such data might require a separate, more highly-secured channel, for the retrieval of such information.

It will be apparent to the skilled person as well that steps 407 and 408 in FIG. 4 are also presented at a very high level, and may also have further detailed levels of processing required to successfully complete a transaction. For example, in some versions of the invention there will be logic for ambiguity resolution. In the processing of a transaction and matching to tagged fields of a template there could be two names, the name of the caller, for example, and the name of a person the caller might be inquiring about. There will need to be logic to be sure which is the caller, and that logic may be enhanced by any one of several means, such as caller ID, GPS location, matching with archived data, and so on. There may also be instances of uncertainty in caller input, and the system may need to ask a caller to repeat or clarify an input, if the system is not satisfied the right information is provided.

In some implementations there may be a context-dependent message structure depending, for example, on a user's identity or values provided for certain fields. That is, a value sought from a user might be dependent on a date or time, or some other variable, and the system may have to check the variables against the input to verify the value of the input. There might, in some implementations, be pre-populated messages, such as, for example, for all parents of students in a particular class who are asked to approve a fieldtrip.

Logic may also be provided in many implementations for conflict resolution. For example, in the circumstance of a staged transaction a user may provide a name similar, but not exactly, the name provided in a previous stage, and the system may need to question whether the person is, in fact, the same person. There may be many other circumstances where information may be entered more than once, and in a slightly, or grossly different way, and the system must have a way to resolve these issues. Resolution will be, in most cases, implementing a further inquiry or call back to the user.

The user may record a message greeting or IVR prompt in act 403. It is noted herein that only one recorded greeting may suffice for a simple voicemail implementation where the user expects all of the required data to be left in one session or recording. In an IVR system implementation a user may create a first prompt/greeting that has sub-menus. Therefore, more than one template may be created for the IVR application such as one for the first prompt that has fields representing the different submenus. The submenus may each be associated with a template created around the contexts of the subject of those submenus.

It is noted herein and will be appreciated by the skilled person that a template may also be created for a text-based message service without departing from the spirit and scope of the present invention. The only difference between the voice-based system and the text-based system is in the method used to recognize and capture the data. For voice, voice recognition logic is used while text recognition logic may be used to parse typed input and DTMF keyed input.

The system begins to process a call in act 404. The system processes a call by first playing the voice or text message. In a text-based implementation the request is opened and parsed for content. In the implementation using voice, a greeting may be presented in act 405. The greeting may be a simple voice recording greeting a caller such as in the case of voicemail. The greeting may solicit data expected from the caller. The caller uses natural language or DTMF input to leave the solicited data. The data may be recorded in the same order as solicited in the greeting or it may be recorded in random or unordered fashion relative to the order of the items mentioned in the greeting.

In one implementation using IVR, a menu prompt may be presented to the caller. The menu prompt may list one or more categories the caller may select via voice or DTMF keying. Data fields in the process template associated with the prompt represent the mentioned categories. In one IVR implementation, IVR tree navigation may be used to get a caller to a submenu that is about (context) a single subject and that requires data from the caller to accomplish a process or transaction relative to that particular subject. In addition to a voice or text prompt a technique may also be used wherein the system may provide, perhaps in a separate channel, a visual prompt or direction to the user.

It may be determined whether there is requestor caller, message sender) input left in a message or recording at act 406. If it is determined that there is no input after the greeting (voice) is played then the process may end for that request. The process may loop back to step 404. If it is determined that there is input left by the caller at act 406 the system may parse or otherwise disseminate the input and match it to template classification tags at act 407. In one embodiment, the system may be configured to recognize key words in the utterance for determining the appropriate template classification tags. For example, the system may be configured to identify and match a phrase such as “My name is,” to a “name” template classification tag. The words following this phrase will then be input into the “name” field of the template. The system may also be configured to identify utterance of numbers as a match to a “phone number” classification tag, and store the number into the “phone number” field of the template. In another example, utterances such as dates may be matched to a “birthdate” tag. Utterance of the word “at” may be matched to an “email address” tag.

In one implementation data is being parsed and matched to template fields in real or near real time. In this way a caller may stay in session to await a confirmation prompt or one that may inform the requestor of specific missing data or to correct an error or to clear up confusion in data received.

It may be determined at act 408 whether a template expected to contain data captured from the incoming message is complete, meaning all of the fields are filled with the correct information. If it is determined that the template is complete then the process may end for that call as a process or transaction relative to the subject may be completed without further involvement of the caller or sender of a message. A confirmation of success may be presented to the caller as a prompt (voice) or a message (text). If it is determined that the template is not complete in act 408, the system may first look for the data elsewhere such as from a network-connected and system accessible resource. In act 409 the system determines whether the missing data is available from a resource other than the caller.

If the data is available from a resource other than the caller at act 409, the data may be retrieved from the data source in act 410. The process may then loop back to act 408 and may branch accordingly based upon the results of the determination at act 408. If it is determined that the missing data is not available at act 409, the system may send a prompt or text message soliciting the missing data at act 411. In one implementation the data is available but there is more than one data set such as two addresses tied to the requestor. In this case the prompt sent in act 411 may ask the requestor to clarify which data set is correct or preferred. There may be additional circumstances, as well, wherein the caller may be asked by the system to confirm or qualify a response. The process loops back to act 407 from act 411 and then back to determination if the template is complete in act 408.

In one implementation all interaction is recorded and preferred channels, media, address information, contact information, and other requestor preferences may be learned by the system. Interaction chains detailing ongoing business between the caller and the called destination may be archived and data mined for preferences and for identifying further needs of the caller relative to upgrade services or related service or products being promoted or that caller input has otherwise indicated.

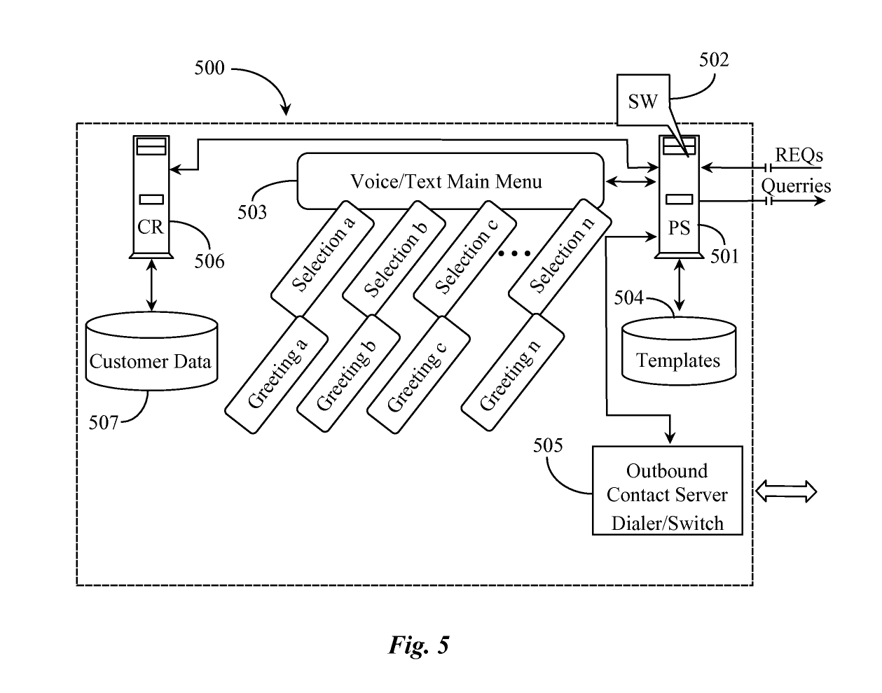

FIG. 5 is a block diagram depicting components 500 for managing input solicited from a caller according to an implementation of the present invention. Component domain 500 (bounded by broken rectangle) includes a process server 501 that includes at least one processor, a data repository, and a memory storing all the data and instruction required to process data received in messages or through a voice interface. In this implementation process server 501 is capable of messaging in text including text messages having voice messages embedded therein or attached thereto.

Server 501 has connection to a data repository 504 storing logic templates analogous to template 200 of FIG. 2 above. Repository 504 may be analogous to repository 111 of FIG. 1 above. Server 501 hosts SW 502, which may be analogous in description to SW 109 of FIG. 1 above. Server 501 has connection to an outbound contact server having a dialer or representing a switch capable of contacting requestors by text message or voice message or call.

In one implementation a main voice or text menu 503 may be presented to callers to help direct them toward a particular subject matter. Menu 503 may include two or more selectable subjects or categories that maybe presented as a list of options in a first prompt to a caller. If text based, a message might be sent to a caller with the main text menu and the selection options. In one implementation using text, the menu may be interactive and may be expanded upon interaction to produce the available selections a through n. In this case the requestor may say or type or otherwise activate a selection (a-n) to obtain a greeting (a-n) associated with the specific selection.

In a use case example, a caller may phone into a service center that services more than one make or model of equipment possessed by the caller. If a caller hears a first greeting (voicemail) that solicits the caller to choose one of a list of selections (options) the caller may choose a selection by DTMF keypad, voice, typing or interacting with a link (Web service interface). Upon selection of the subject or category, a greeting might be presented to the caller that is contextually representative of acknowledgment of the caller and that may inform the caller of the type or types of data the process or system will need to be left on recording or in a message to the system.

In this implementation requests (REQs) into server 501 come from callers connected to the external network. In another implementation the system of the invention may be practiced internally within an enterprise on a wide area network (WAN) or local area network (LAN). The callers may be sales agents, for example, and the receiving entity may be a resource server or sales accounting system. There are many possibilities. Queries may be prepared and sent out to callers or to other servers controlling other data sources connected to the network. A message sent to a caller soliciting a missing piece of data may be a query to that particular caller.

Server 501 has network connection to a customer relations management server 506. Server 506 includes a processor, at least one data repository coupled thereto and a memory containing thereon all of the data and instruction required to enable function as a customer relations management server. Server 506 has connection to a data repository 507 storing data about customers. Server 506 and repository 507 may be analogous to server 103 and repository 107 of FIG. 1. Server 506 may be a third-party hosted server or a first-party hosted server without departing from the invention. In this implementation server 506 is first-party hosted. In this implementation, components 500 may be located in a service center or call center.

In one implementation calls that are active may be queued after caller input is provided. In such as case a prompt or message may be delivered to a caller informing the caller of an unexpected delay suspending the interaction and providing a link or key to resuming the interaction at a later time. In one implementation the system may be trained according to language or dialogue of a requestor (personalization). The system may learn phrases, pronunciation, and terms more familiar to a requestor. In the case of n interrupted session, the position in the session may be saved, so that the system may pick up at the same point on re-connecting with the same caller.

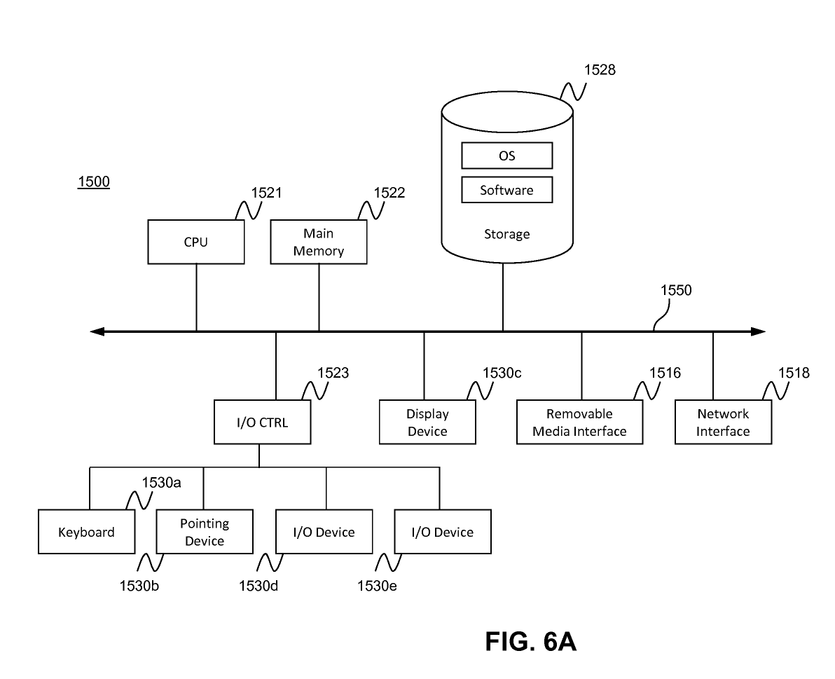

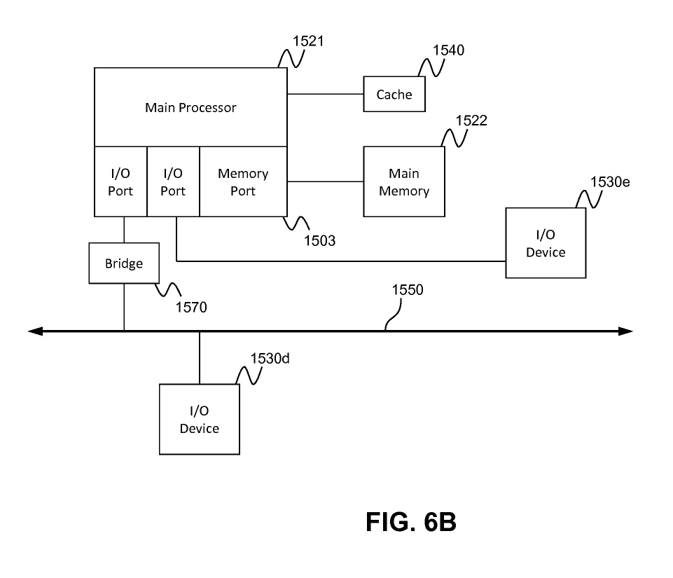

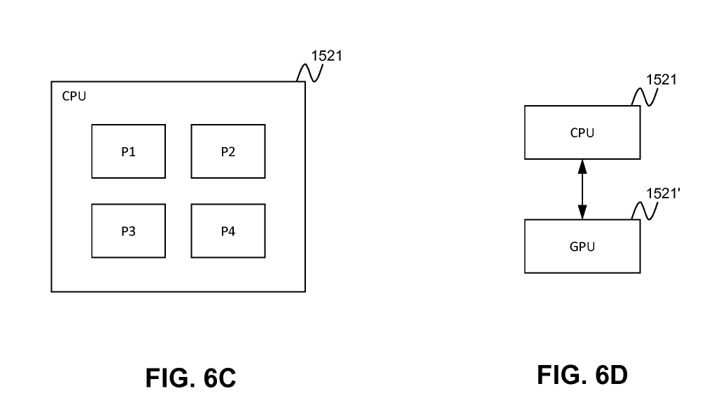

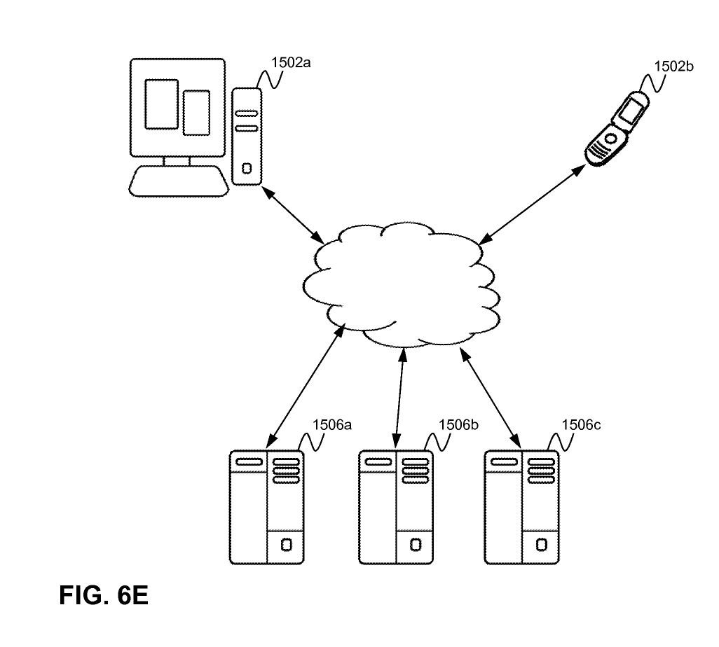

Each of the various servers, controllers, switches, gateways, engines, and/or modules (collectively referred to as servers) in the afore-described figures may be a process or thread, running on one or more processors, in one or more computing devices 1500 (e.g., FIG. 6A, FIG. 6B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments of the present invention, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JavaScript Object notation (JSON).

FIG. 6A and FIG. 6B depict block diagrams of a computing device 1500 as may be employed in exemplary embodiments of the present invention. Each computing device 1500 includes a central processing unit 1521 and a main memory unit 1522. As shown in FIG. 6A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 6B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 6A, the central processing unit 1521 communicates with the main memory 1522 via a system bus 1550. As shown in FIG. 6B, the central processing unit 1521 may also communicate directly with the main memory 1522 via a memory port 1503.

FIG. 6B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 6A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 6B depicts an embodiment of a computer 1500 in which the central processing unit 1521 communicates directly with I/O device 1530e. FIG. 6B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 6A, may control the I/O devices. The I/O controller may control one or more I/O devices such as a keyboard 1530a and a pointing device 1530b, e.g., a mouse or optical pen.

Referring again to FIG. 6A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further comprise a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may comprise or be connected to multiple display devices 1530c, which each may be of the same or different type and/or form. As such, any of the I/O devices 1530 and/or the I/O controller 1523 may comprise any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530c. In one embodiment, a video adapter may comprise multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 6A and FIG. 6B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 comprises a combination of devices, such as a mobile phone combined with a digital audio player or portable media player.

As shown in FIG. 6C, the central processing unit 1521 may comprise multiple processors P1, P2, P3, P4, and may provide functionality for simultaneous execution of instructions or for simultaneous execution of one instruction on more than one piece of data. In some embodiments, the computing device 1500 may comprise a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 comprises a multicore microprocessor, which combines two or more independent processors into a single package, e.g., into a single integrated circuit (IC). In one exemplary embodiment, depicted in FIG. 6D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may comprise a plurality of machines so connected. FIG. 6E shows an exemplary network environment. The network environment comprises one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 6E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may comprise a built-in network adapter, such as a network interface card, suitable for interfacing the computing device 1500 to any type of network capable of communication and performing the operations described herein. An I/O device 1530 may be a bridge between the system bus 1550 and an external communication bus.

According to one embodiment, the network environment of FIG. 6E may be a virtual network environment where the various components of the network are virtualized. For example, the various machines 1502 may be virtual machines implemented as a software-based computer running on a physical machine. The virtual machines may share the same operating system. In other embodiments, different operating system may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

Other types of virtualization is also contemplated, such as, for example, the network (e.g. via Software Defined Networking (SDN)). Functions, such as functions of the session border controller and other types of functions, may also be virtualized, such as, for example, via Network Functions Virtualization (NFV).

It will be apparent to the skilled person that the arrangement of elements and functionality for the invention is described in different embodiments, in which each embodiment is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A customer contact center system comprising:
a data storage device storing a plurality of templates, each template having a plurality of data input fields;
a communication router connected to one or more communication channels in a network for routing a communication transaction from a sender;
a server connected to the network having a processor coupled to at least one data repository and software executing from a non-transitory medium on the processor, wherein the server is configured to:
receive the routed transaction from the router;
select one of the plurality of templates;
receive a first input from the transaction;
select a first data input field from the plurality of data input fields based on the first input; and
store the first input in association with the first data input field and the sender.

2. The system of claim 1 wherein the network is at least one of a publically switched telephone network (PSTN), a digital cellular network, or a data network.

3. The system of claim 1, wherein the server is further configured to:
identify a second data input field from the plurality of data input fields;
determine, at a preset juncture, whether a second input associated with the second data input field, has been received from the transaction; and
in response to determining that the second input has not been received, prompt the sender for the second input.

4. The system of claim 3 wherein the preset juncture is a pause in the transaction with the sender remaining connected in the transaction, and the server is configured to transmit the prompt during the transaction.

5. The system of claim 3 wherein the preset juncture is disconnection of the transaction, and the server is configured to transmit the prompt in a separate transaction.

6. The system of claim 3 wherein the network supports voice transaction, the transaction is a voice call, and the prompt is a recorded voice message identifying the second input.

7. The system of claim 3 wherein the network supports data transactions, the transaction is a text message, and the prompt is a text message identifying the second input.

8. The system of claim 3 wherein the server supports voice and data transactions, the transaction is at least one of voice or text, and the prompt is a notification utilizing at least one of voice or text.

9. The system of claim 3 wherein the server is configured to:
transmit a request to a source on the network other than the sender of the transaction, for the second input.

10. The system of claim 3, wherein the transaction is a telephony call, the first input includes utterances from the sender during the telephony call, and the server is configured to:
recognize the utterances from the sender;
identify a first tag identifying the first data input field based on the recognized utterances; and
store a text-based representation of at least a portion of the recognized utterances in association with the first data input field and the sender.

11. A method for providing customer contact center services, the method comprising:
receiving a communication transaction at a router connected to one or more communication channels in a network;
routing the transaction for processing to a server connected to the network, the server having a processor coupled to at least one data repository and software executing from a non-transitory medium on the processor;
receiving, by the server, the routed transaction from the router;
selecting, by the server, one of a plurality of templates stored in a data storage device;
receiving, by the server, a first input from the transaction;
selecting, by the server, a first data input field from the plurality of data input fields based on the first input; and
storing, by the server, the first input in association with the first data input field and the sender.

12. The method of claim 11 wherein the network is at least one of a publically switched telephone network (PSTN), a digital cellular network, or a data network.

13. The method of claim 11 further comprising:
identifying, by the server, a second data input field from the plurality of data input fields;
determining, by the server, at a preset juncture, whether a second input associated with the second data input field, has been received from the transaction; and
in response to determining that the second input has not been received, prompting the sender, by the server, for the second input.

14. The method of claim 13 wherein the preset juncture is a pause in the transaction with the sender remaining connected in the transaction, and the server transmits the prompt during the transaction.

15. The method of claim 13 wherein the preset juncture is disconnection of the transaction, and the server transmits the prompt in a separate transaction.

16. The method of claim 13 wherein the network supports voice transaction, the transaction is a voice call, and the prompt is a recorded voice message identifying the second input.

17. The method of claim 13 wherein the network supports data transactions, the transaction is a text message, and the prompt is a text message identifying the second input.

18. The method of claim 13 wherein the system supports voice and data transactions, the transaction is at least one of voice or text, and the prompt is a notification utilizing at least one of voice or text.

19. The method of claim 13 further comprising:
transmitting a request to a source on the network other than the sender of the transaction, for the second input.

20. The method of claim 13, wherein the transaction is a telephony call, the first input includes utterances from the sender during the telephony call, the method further comprising:
recognizing, by the server, the utterances from the sender;
identifying, by the server, a first tag identifying the first data input field based on the recognized utterances; and
storing, by the server, a text-based representation of at least a portion of the recognized utterances in association with the first data input field and the sender.
